(19) United States
(12) Patent Application Publication
(10) Pub. No.: US 2010/0150732 A1
(43) Pub. Date: Jun. 17, 2010

(54) Turbo Wind Turbine and New Method of using Moving Fluid Energy

(75) Inventor: Zahid Kamal Khuwaja, Abu Dhabi (AE)

Correspondence Address: Zahid Kamal Khuwaja, 801, HSBC Bank Building, Airport Road, Abu Dhabi, Abu Dhabi, 665, AE

(73) Assignee: Zahid Kamal Khuwaja, Abu Dhabi (AE)

(21) Appl. No.: 12/335,939

(22) Filed: Dec. 16, 2008

(51) Int. Cl. F03D 3/06; F01D 7/00

(52) U.S. Cl. 416/93 A; 416/1; 416/147

(57) ABSTRACT

Disclosed are the various embodiments of turbines that depicts a method of capturing wind or other moving fluid energy as rotor hub is placed perpendicular to wind direction and plurality of propeller wing having generally rectangular structure are rigidly joined to the hub and are pushed by the kinetic force of wind to rotate co-current to wind direction during leading half path of any single rotation; thereby, plurality of louvers rotatably held from their longitudinal extremities as inset of peripheral frame of propeller wing are opened during the remaining trailing half path of rotation making them permeable bodies allowing wind to pass through therefore propeller wings move countercurrent to the wind to complete the revolution. This method converts a much larger component of passing wind energy in to rotational movement of central hub that is subsequently used to generate electricity using generator mean or do other useful work.

### BACKGROUND OF THE INVENTION

The invention relates generally to the field of fluid driven turbines, such as wind turbines or water turbines, wherein one of the embodiment, electrical power is generated from air or water flow across rotor wings. More particularly, the invention relates to such turbines wherein the propeller wings have body that can be transformed from permeable to non-permeable and non-permeable to permeable during any single rotation.

Wind turbines, also known as windmills, wind generators, wind machines or the like, are well known devices for producing energy, typically electrical energy by harnessing the power of wind. However, such fan shaped turbines have angled blades mounted on central shaft aligned with wind direction; rotate in sweeping action across the wind direction to capture its energy. Due to across the wind movement of blades, a comparatively small portion of wind energy is yielded by wind turbine. Therefore, to produce substantial electrical energy, wind turbines are very large structures, standing hundreds of feet tall and having rotor blades extending hundreds of feet. Large elongated blades are required since the area of wind sweep is proportional to the power that can be produced by a given wind turbine thus requiring such wind turbines to have very large structure. Therefore, wind front area used by such turbines is not utilized efficiently.

an alternative type of wind turbine, rotor hub is placed perpendicular to wind direction and plurality of propeller wing having generally rectangular structure are joined to hub are pushed by kinetic force of wind to rotate co-current to wind direction during leading half path of any single rotation; thereby, plurality of louvers rotatably held from their longitudinal extremities as inset of peripheral frame of propeller wing are opened during the remaining trailing half path of rotation making them permeable bodies allowing wind to pass through therefore propeller wings move countercurrent to the wind to complete the revolution. This method converts a much larger component of passing wind energy in to rotational movement of central hub that is subsequently used to generate electricity using generator mean or do other useful work.

It is therefore object of invention, to provide a highly efficient turbine that captures a larger component of kinetic energy of passing fluid.

### SUMMERY OF THE INVENTION

Disclosed is a method of capturing wind or other fluid energy using turbo turbine, wherein a plurality of generally flat structured propeller wing members rigidly installed to hub shaft member as pairs in a way that two propeller wing members of any of said pair are on exactly opposite sides of hub shaft member and put hub shaft member in to rotational movement when one propeller wing member of the pair is pushed co-current to passing fluid by its kinetic force as it has non-permeable body during leading half path of any single rotation while propeller wing member on opposite side of hub is in trailing half path of rotation thus moving counter-current to passing fluid because it has permeable body not resisting passing fluid; thereupon, rotation is completed as permeable body propeller wing member is in leading cycle as it is transformed to have non-permeable body thus moving co-current to passing fluid by its kinetic force while at the same time non-permeable body propeller wing member is in trailing half cycle as it is transformed to have permeable body and moves counter-current to passing fluid.

An embodiment of the present invention comprises a Turbo wind turbine, powered by wind for generating electrical power wherein central hub is joined with plurality of propeller wing. Propeller wing member each comprising a peripheral frame and a plurality of louvers disposed therein. Louvers are rotatably held to peripheral frame from their longitudinal extremities. Louvers are rotatable along their longitudinal central inner axis by a drive mechanism, drive mechanism comprise louver gear wheel, louver drive chains, non-drive-end support gear wheels, drive-end gear wheels, motor gear wheels and motors. Central hub and propeller wings define a predetermined, volume-occupying, three-dimensional configuration of fluid turbine that is caused to rotate by the kinetic force of passing fluid as method explained above.

REFERENCE US PATENT DOCUMENTS

| 2,896,882 A | July 1959 | Nelson | 4,830,570 A | May 1989 | Benesh |
|---|---|---|---|---|---|
| 3,876,925 A | April 1975 | Stoeckert | 4,838,757 A | June 1989 | Benesh |
| 3,895,882 A | July 1975 | Moyer | 4,843,249 A | June 1989 | Bussiere |
| 3,922,012 A | November 1975 | Hen | 4,890,976 A | January 1990 | Jensson |
| 3,938,907 A | February 1976 | Magovenyet aI. | 4,960,363 A | October 1990 | Bergstein |
| 3,986,786 A | October 1976 | Sellman | 4,979,871 A | December 1990 | Reiner |
| 4,031,405 A | June 1977 | Asperger | 5,020,967 A | June 1991 | Gual et al. |
| 4,037,983 A | July 1977 | Poeta | 5,037,268 A | August 1991 | Fenlon |
| 4,047,833 A | September 1977 | Decker | 5,038,049 A | August 1991 | Kato |
| 4,057,270 A | November 1977 | Lebost | 5,126,584 A | June 1992 | Ouellet |
| 4,070,131 A | January 1978 | Yen | 5,133,637 A | July 1992 | Wadsworth |
| 4,079,264 A | March 1978 | Cohen | 5,163,813 A | November 1992 | Schlenker |
| 4,084,918 A | April 1978 | Pavlecka | 5,203,672 A | April 1993 | Wolf |
| 4,088,419 A | May 1978 | Hope et al. | 5,246,342 A | September 1993 | Bergstein |
| 4,115,027 A | September 1978 | Thomas | 5,269,647 A | December 1993 | Moser |
| 4,115,028 A | September 1978 | Hintze | 5,280,827 A | January 1994 | Taylor |
| 4,116,581 A | September 1978 | Bolie | 5,287,004 A | February 1994 | Finley |
| 4,119,863 A | October 1978 | Kelly | 5,313,103 A | May 1994 | Hickey |
| 4,132,282 A | January 1979 | Sparks | 5,333,996 A | August 1994 | Bergstein |
| 4,154,556 A | May 1979 | Webster | 5,336,933 A | August 1994 | Ernster |
| 4,156,580 A | May 1979 | Pohl | 5,380,149 A | January 1995 | Valsamidis |
| 4,164,382 A | August 1979 | Mysels | 5,386,146 A | January 1995 | Hickey |
| 4,174,923 A | November 1979 | Williamson | 5,391,926 A | February 1995 | Stal ey et aI. |
| 4,204,796 A | May 1980 | Pack | 5,454,694 A | October 1995 | O'Dell |
| 4,234,289 A | November 1980 | Lebost | 5,463,257 A | October 1995 | Yea |
| 4,236,866 A | December 1980 | Zapata Martinez | 5,503,525 A | April 1996 | Brown et aI. |
| 4,260,325 A | April 1981 | Cymara | 5,553,996 A | September 1996 | Farrar |
| 4,270,056 A | May 1981 | Wright | 5,844,324 A | December 1998 | Spriggle |
| 4,278,896 A | July 1981 | McFarland | 5,852,331 A | December 1998 | Giorgini |
| 4,288,200 A | September 1981 | O'Hare | 5,895,201 A | April 1999 | Huovinen |
| 4,295,783 A | October 1981 | Lebost | 6,000,907 A | December 1999 | Bic |
| 4,309,146 A | January 1982 | Hein et aI. | 6,015,258 A | January 2000 | Taylor |
| 4,350,900 A | September 1982 | Baughman 290/55 | 6,083,382 A | July 2000 | Bird |
| 4,365,929 A | December 1982 | Retz | 6,109,863 A | August 2000 | Milliken |
| 4,423,368 A | December 1983 | Bussiere | 6,113,350 A | September 2000 | Liu |
| 4,452,562 A | June 1984 | Hsu | 6,138,781 A | October 2000 | Hakala |
| 4,457,666 A | July 1984 | Selman, Jr. | 6,158,953 A | December 2000 | Lamont |
| 4,474,529 A | October 1984 | Kinsey | 6,191,496 B1 | February 2001 | Elder |
| 4,486,143 A | December 1984 | McVey | 6,309,172 BI | October 2001 | Gual |
| 4,490,232 A | December 1984 | Lapeyre | 6,406,251 B1 | June 2002 | Vauthier |
| 4,496,848 A | January 1985 | Binder | 6,448,669 B1 | September 2002 | Elder |
| 4,551,631 A | November 1985 | Trigilio | 6,538,340 B2 | March 2003 | Elder |
| 4,575,311 A | March 1986 | Wood | 0192069 A1 | December 2002 | Newman |
| 4,606,697 A | August 1986 | Appel | 0026684-\1 | February 2003 | Bohn |
| 4,717,832 A | January 1988 | Harris | 5315159 | May 1994 | Gribnau |
| 4729716 | March 1988 | Schmidt | 5436508 | July 1994 | Sorensen |
| 4549729 | October 1985 | Storm | 6664645 | December 2003 | Vann |
| 4350589 | September 1982 | Cook | | | |
| 4330714 | May 1982 | Smith | | | |
| 5319865 | March 1982 | Richard | | | |
| 4276033 | June 1981 | Krovina | | | |
| 4220870 | September 1981 | Kelly | | | |
| 4204796 | May 1981 | Pack, Jr. | | | |
| 2855179 | October 1958 | Brown | | | |
| 243169 | June 1981 | Sprague | | | |

### BRIEF DESCRIPTION OF THE FIGURES

FIG. 1 is a top perspective view of an embodiment of inventions as Turbo wind turbine.

FIG. 2 is a front elevation view of an embodiment of inventions as Turbo wind turbine.

FIG. 3 is a side elevation view of embodiment of inventions as Turbo wind turbine.

FIG. 4 is a top elevation view of embodiment of inventions as Turbo wind turbine.

FIG. 5 is a detail view of the louver drive mechanism housed inside the rotor assembly.

FIG. 6 is a top plan view of an embodiment invention as Turbo wind turbine having four propeller wings.

### DETAILED DESCRIPTION OF THE INVENTION

With reference to the drawings, the invention will now be described in detail with regard for the best mode and the preferred embodiment. In a broad sense, the invention is a fluid powered turbine, such as a wind turbine or a water turbine, where wind or flowing water rotates a rotor element about a central shaft or hub member comprises a plurality of propeller wing members that rotate around central hub member. For simplicity herein, the invention shall be described using wind as the fluid medium, but it is to be understood that the invention is operational as well with a flowing liquid, such as water.

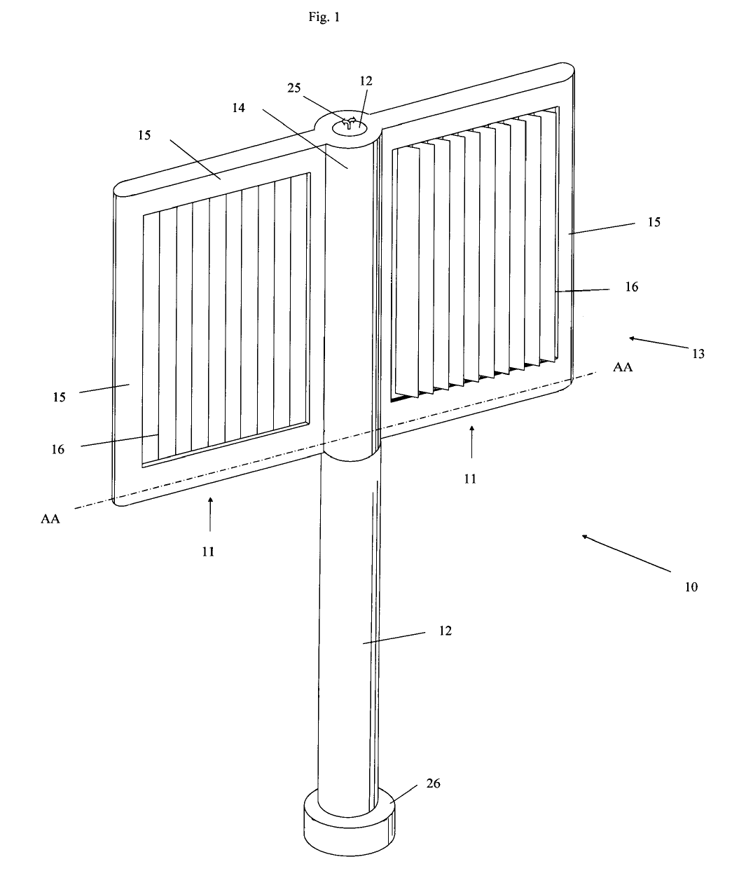

As the embodiment shown in FIG. 1, the invention is a turbine 10, comprising a rotor assembly 13 mounted on a fixed sport mean, shown as comprising a base member 26, a tower member 12, and a central rotating hub member 14 whereby, the rotor assembly 13 is positioned to have a generally vertical axis of rotation in order to absorb the energy of wind passing across. The turbine 10 may be of any size, and the structure as described herein is suitable for small to very large turbines, whereas the spread of the rotor assembly 13 may range widely.

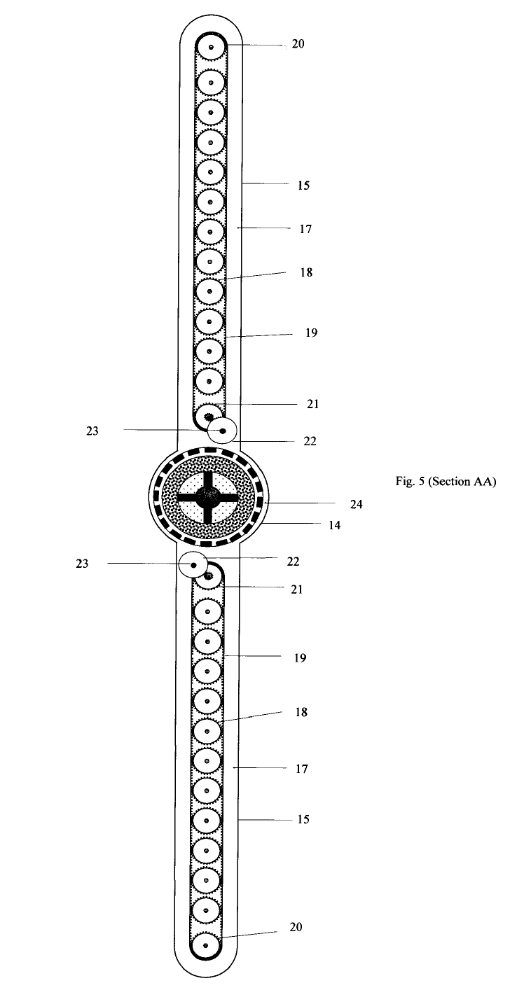

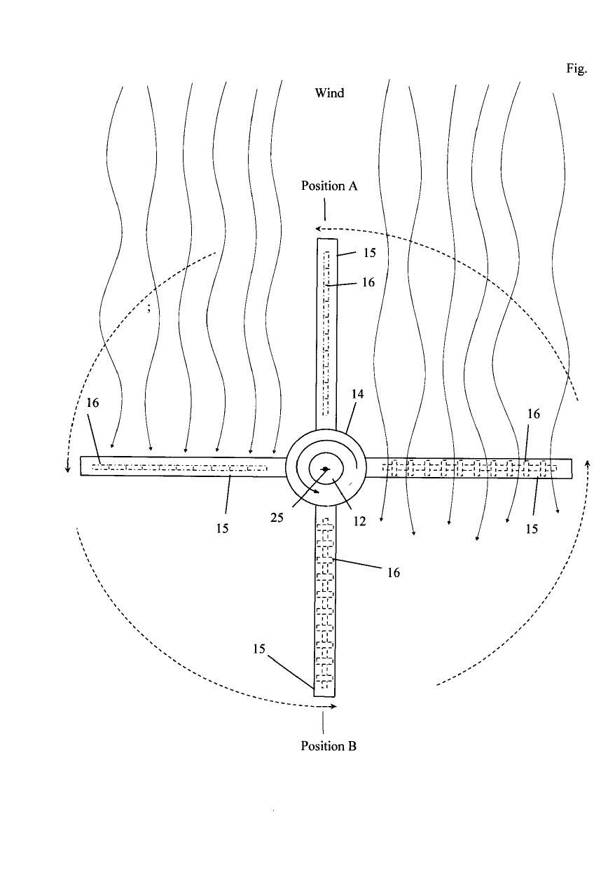

The rotor assembly 13 comprises a central annular rotating hub member 14 mounted to the fix support member 12 such that the rotor assembly 13 can rotate relative to the fixed support means. The rotor assembly 13 further comprises rectangular shaped propeller wing member 11, being joined to the central hub member 14 by a plurality of propeller wing members 11. Each propeller wing member 11 comprises a set of louvers 16, housed inside the peripheral frame member 15; each louver 16 is held to frame member 15 from both longitudinal extremities and rotatable along its central inner axis by means of louver drive mechanism 17 shown in FIG. 5. The louvers 16 have vertical orientation in the embodiment shown. The rotor assembly 13 being the means to capture the energy of the wind and transform it into rotational movement and may comprise of plurality of wing member 15.

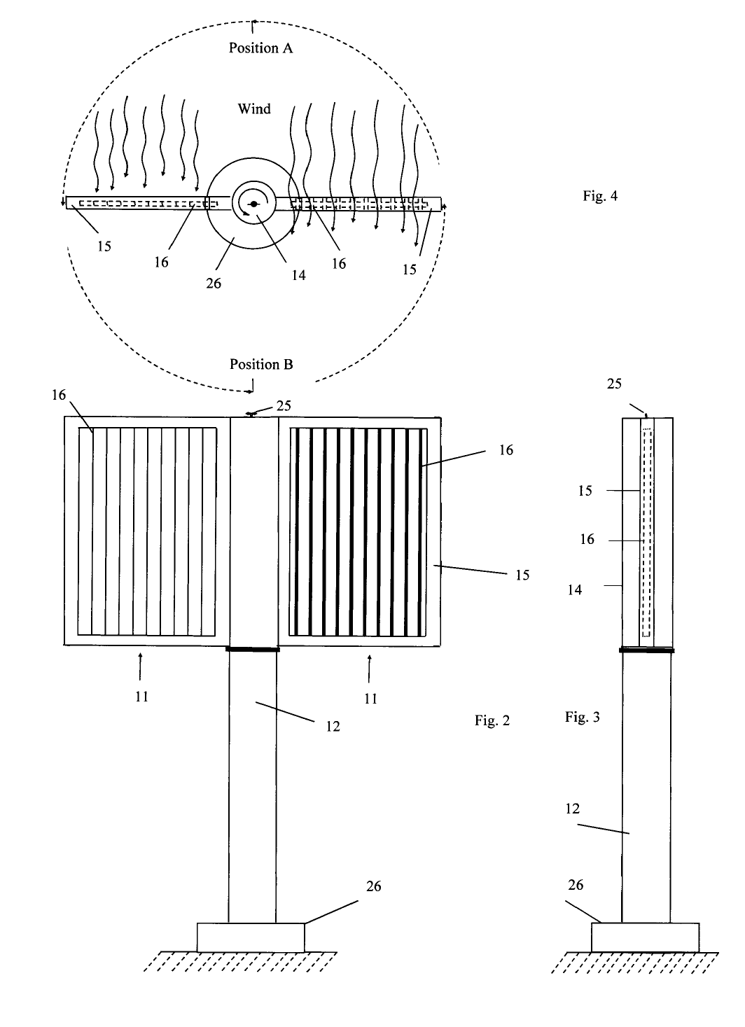

In the embodiment shown in FIG. 1 to 5, rotor assembly 13 have two propeller wing members 11 fixed to either side of shaft member 14 and each having a frame member 15, set of louver member 16 and drive mechanism 17 where drive mechanism 17 sequentially rotate louvers member 15 along their longitudinal central inner axis. Explained in FIG. 4, sequenced rotational movement of louvers 16 is critical to effect the rotation of rotor assembly 13, while rotor assembly is in perpendicular position to wind direction, set of louver members 16 in one propeller wing member 11 are positioned parallel to its frame member 15 and the set of louver member 16 in the other propeller wing member 11 are positioned perpendicular to its frame member 15; such that while one propeller wing member 11 has non-permeable body and is pushed by the kinetic force of wind co-current to the wind, other propeller wing member 11 has permeable body allowing air to pass through and moving counter-current to the wind. There onwards, when the rotor assembly 13 is in position parallel to wind direction, louvers drive mechanism 17 change position of set of louver 16 that are parallel to their respective frame member 15 to perpendicular as well as change position of set of louver 16 that are perpendicular to their respective frame member 15 to parallel; such that propeller wing member 11 which earlier had permeable body now becomes non-permeable and is pushed by the kinetic force of wind co-current to the wind, at the same time, other propeller wing member 11 which had non-permeable body now become permeable allowing air to pass through and moving counter-current to the wind. The continuous repetition of combination of these movements put the rotor assembly 13 in to rotation. The wind sensor 25 detects the wind direction and determine the “Position A” being a position towards and parallel to incoming wind with respect to the location of wind sensor 25 and “Position B” being at 180 degree opposite to “Position A”. Accordingly when any propeller wing member 11 reaches “Position A”, its drive mechanism 17 position set of louver 16 parallel to its frame member 15 as well as position set of louver member 16 of propeller wing member 11 at “Position B” perpendicular to its frame member 15.

The louvers drive mechanism 17, housed inside the lower horizontal arms of the wing 15, is shown in FIG. 5 as bottom-up plan view section AA of rotor assembly 13 in FIG. 1. Drive mechanism 17 comprise louver gear wheel 18, louver drive chains 19, non-drive-end support gear wheels 20, drive-end gear wheels 21, motor gear wheels 22 and motors 23 to provide the sequenced rotation of set off louvers 16 around the centre of vertical axis of individual louver 16. Motors 23 rotate motor gear wheels 22 that further rotate drive-end gear wheels 21; drive-end gear wheels 21 further transfer this rotation to the set louvers 16 through louver drive chains 19.

In the embodiment, the rotational energy of the rotor assembly 13 may be transferred to generator means 24 via rotating central hub member 14. Such systems are well known.

In another embodiment, rotor assembly member 13 has four propeller wing members with each having a frame member 15, set of louver member 16 and drive mechanism 17 which work on the same principle as explained in Para [0014] and shown in FIG. 6. The wind sensor 25 detects the wind direction and determine the “Position A” being a position towards and parallel to incoming wind with respect to the location of wind sensor 25 and “Position B” being at 180 degree opposite to “Position A”. Accordingly when any propeller wing member 11 reaches “Position A”, its drive mechanism 17 position set of louver 16 parallel to its frame member 15 as well as position set of louver member 16 of propeller wing member 11 at “Position B” perpendicular to its frame member 15.

In another embodiment, said frame is connected to said frame through connecting arms, thus providing gap between the hub and propeller wings that smoothen wind currents around the two propeller wings and also provide extra leverage for impact of wind force on propeller wings more powerful hub rotation.

It is understood that equivalents and substitutions for certain elements set forth above may be obvious to those skilled in the art, and therefore the true scope and definition of the invention is to be as set forth in the following claims

I claim:

1. A method of capturing wind or other moving fluid energy and transform it in to electricity or other useful mechanical work, wherein a plurality of generally flat structured propeller wing members rigidly installed to hub shaft member as pairs in a way that two propeller wing members of any of said pair are on exactly opposite sides of said hub member and put said hub shaft member in to rotational movement when one propeller wing member of said pair is pushed co-current to passing fluid by its kinetic force when said one propeller wing member has non-permeable body during leading half path of any single rotation while other propeller wing member of said pair is in trailing half path of said single rotation thus moving counter-current to passing because it has permeable body not resisting passing fluid; thereupon, rotation is completed as permeable body propeller wing member is in leading cycle as it is transformed to have non-permeable body and moves co-current to passing fluid by its kinetic force while at the same time non-permeable body propeller wing member is in trailing half cycle as it is transformed to have permeable body and moves counter-current to passing fluid.

2. Method of claim 1, wherein said propeller is structured using suitable components to transform its body from permeable to non-permeable or non-permeable to permeable during any single rotation.

3. Method of claim 1, wherein method of generating energy further comprise said propeller wing member having plurality of louvers rotatably held from their longitudinal extremities as inset of peripheral frame of said propeller wings member; said louvers can be positioned parallel and perpendicular to said frame axis to make said propeller wing member non-permeable and permeable respectively.

4. A fluid turbine, powered by wind or water comprising:
A propeller assembly comprising a rotating annular hub member, a generator means, a central inner fix support member and a plurality of rotating propeller wing members, said annular rotating hub member joined with plurality of said propeller wing members. Said wing member each comprising a peripheral frame and a plurality of louvers disposed therein as inset. Said louvers are rotatably held to peripheral frame from their longitudinal extremities. Said louvers are rotatable along their longitudinal central inner axis by drive mechanism, said drive mechanism comprise louver gear wheel, louver drive chains, non-drive-end support gear wheels, drive-end gear wheels, motor gear wheels and motors. Central hub and propeller wings define a predetermined, volume-occupying, three-dimensional configuration of fluid turbine that is caused to rotate by the kinetic force of passing fluid.

5. The turbine of claim 4, further comprising generator means, and wherein said generator means is disposed in between said annular hub and said fix support member whereby rotational force is transferred from said hub member to said generator means.

6. The turbine of claim 4, wherein said annular hub member is aligned to said inner fix member.

7. The turbine of claim 4, wherein propeller wings are three dimensionally aligned to the central hub.

8. A turbine, powered by wind or water for generating electrical power comprising:
A fix column support member and a propeller assembly comprising a rotating central annular hub member and rotating propeller wing, said central hub joined with plurality of said propeller wing. Said propeller wing member each comprising a peripheral frame and a plurality of louvers disposed therein. Said louvers are rotatably held to peripheral frame from their longitudinal extremities. Said louvers are rotatable along their longitudinal central inner axis by a drive mechanism, said drive mechanism comprise louver gear wheel, louver drive chains, non-drive-end support gear wheels, drive-end gear wheels, motor gear wheels and motors. Central hub and propeller wings define a predetermined, volume-occupying, three-dimensional configuration of fluid turbine that is caused to rotate by the kinetic force of passing fluid.

9. The turbine of claim 8, further comprising generator means, wherein rotational force is transferred from said hub member to said generator means.

10. The turbine of claim 8, comprising generator means, wherein said generator means are disposed between the said annular hub and said support member.

11. The turbine of claim 8, comprising generator means, wherein said generator means are disposed outside the body of said annular hub member.

12. The turbine of claim 8, wherein said propeller wings are attached to at least one central hub in curved configuration.

13. The turbine of claim 8, wherein said propeller wings comprise at least one peripheral frame each.

14. The turbine of claim 8, comprising propeller wings wherein said louvers are rotatably held to at least one said peripheral frame in linear configuration.

15. The turbine of claim 8, comprising set of louver, wherein position of set of louver member is adjustable to parallel and perpendicular position with respect to said frame axis.

16. The turbine of claim 8, comprising drive means wherein said drive means rotate the set of louver member to parallel and perpendicular position with respect to said frame axis.

17. The turbine of claim 8, wherein said propeller assembly has number of propeller wing members is selected from group consisting of 2, 4, 6, 8 or 10.

18. The turbine of claim 8, wherein one of the embodiments, one side of said frame member of said of said propeller wing member is fully attached to said hub.

19. The turbine of claim 8, wherein one of the embodiments, one side of said frame member of said propeller wing member is partially attached to said hub using elongated arms providing substantially large void space in between propeller wing member and said frame member for wind flow.

20. The turbine of claim 8, wherein one of the embodiments, said wing members are curved concavely in one direction for horizontal spread from central hub to outer extremities.
